(19) United States
(12) Patent Application Publication
(10) Pub. No.: US 2024/0071072 A1
(43) Pub. Date: Feb. 29, 2024

(54) MICROPLASTICS DETECTOR SENSOR COUPLING AND DATA TRAINING

(71) Applicant: X Development LLC, Mountain View, CA (US)

(72) Inventors: Anne LaBine, San Francisco, CA (US); Chandramouli Venkatesan, Sunnyvale, CA (US)

(21) Appl. No.: 18/241,000

(22) Filed: Aug. 31, 2023

Related U.S. Application Data
(60) Provisional application No. 63/402,644, filed on Aug. 31, 2022.

(51) Int. Cl. G06V 20/05; G06V 10/12; G06V 10/764; G06V 10/774

(52) U.S. Cl. CPC G06V 20/05; G06V 10/12; G06V 10/764; G06V 10/774

(57) ABSTRACT

Methods, systems, and apparatus, including computer programs encoded on computer-storage media, for receiving sensor data and refining a training model for microplastics detector. In some implementations, an exemplary method includes receiving microplastics detection data from a microplastics detection sensor and additional sensor data from one or more other sensors; providing the microplastics detection data and additional sensor data to a model trained to detect microplastics; receiving one or more values representing the amount of microplastics from the microplastics detection data and additional sensor data; and providing a representation of the one or more values for output of the model describing the amount of microplastics for use by one or more user devices.

### CROSS-REFERENCE TO RELATED APPLICATION

This application claims the benefit of U.S. Provisional Application No. 63/402,644 filed on Aug. 31, 2022, the entirety of which is herein incorporated by reference.

### FIELD

This specification generally relates to plastic detection, and particularly to detecting microplastics within aquaculture environments.

### BACKGROUND

Plastic is a common material used for products and applications from various sources. The prevalence of plastic, however, presents an issue due to its relatively long decomposition time e.g., hundreds to thousands of years. As plastics decompose, microplastics resulting from plastic decomposition release into ecosystems and pollute the environment. In addition to environmental pollution, the global demand for beef drastically contributes to climate change due to deforestation and sizeable water footprint. The resulting deforestation due to beef consumption rapidly increases greenhouse gas emissions and decreased carbon sequestration. Aquaculture is an emerging alternative farming practice to beef cattle farming, as a sustainable and suitable protein source replacement to beef without increasing carbon emissions and thereby mitigating the effects of climate change.

### SUMMARY

In general, innovative aspects of the subject matter described in this specification relate to improved microplastics detection by utilizing plastic detection sensor data in addition to sensor data from other sensors, by a trained model. The plastic detection data and additional sensor data, otherwise referred to sensor measurements, can be immediately processed, or stored for later processing, depending on processing bandwidth and current, or projected, processing load.

Accurate microplastics detection in the aquaculture environment presents many complex challenges ranging from visual disruptions to microplastics sensors due to marine snow, debris, fish excrement, etc. and physical disruptions from fish interacting with sensors and the presence of other sea life in the aquaculture environment. As a consequence, without coupling microplastics detection sensors and data training, microplastics detectors are likely to miss detections of microplastics in complex aquaculture environments. These missed detections may result in fish consuming microplastics, which may lead to illness or death throughout a population of fish, as well as concomitant food chain disruptions and negative health effects when consumers of fish eat these fish themselves. Therefore, in addition to the positive environmental effects, the utilization of one or more sensors to improve detectability of microplastics in the aquaculture environment can have a positive effect on the health of an entire food chain.

As an additional consequence, missing microplastics detections from a microplastics detector can result in fish consuming microplastics—which has an adverse effect on their overall happiness and well-being. It is imperative to accurately detect and prevent fish from consuming microplastics, particularly in aquaculture environments that can be accommodated for the benefit of the fish. Healthy fish also have an highly beneficial impact on oceans by contributing nutrients and supporting marine ecosystems.

To improve microplastics detection, the techniques herein describe a system receiving multiple set of training data, each set including microplastics detection sensor data, other data associated with an underwater camera system, and a label describing an amount of microplastics. In the system, a training model can identify one or more sensor measurements from the microplastics detection sensor data using the multiple sets of training data and transmit both the training model and the multiple sets of training data to one or more user devices. In some implementations, the system is configured to perform an action to configure one or more user devices upon receipt of the training model, the one or more sensor measurements, or the multiple sets of training data.

Updated representations of one or more values for output of microplastics detection may be used to determine subsequent actions, e.g., controlling the amount of feed given to a fish population. Controlling the amount of feed can be accomplished by controlling a feed distribution system.

In an aquaculture environment, a system for coupling microplastics detection and training as described herein can perform a method that includes receiving sensor measurements from a microplastics detector and one or more other sensors in an underwater camera system, providing the sensor measurements to a microplastics detection engine and training model, and receiving one or more particular values for output from the training model and microplastics detection engine.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

The foregoing and other embodiments can each optionally include one or more of the following features, alone or in combination. For instance, in some implementations, actions include obtaining a type of microplastics to be detected by the trained model.

In some implementations, the system determines that one or more values for output from the microplastics detection engine is greater than a threshold value, indicating the presence of microplastics.

In some implementations, the system obtains at least one or both of a quantity or a concentration of microplastics to be detected by the trained model.

In some implementations, a comparison between the one or more sensor measurements from microplastics detection sensor data and a ground truth measurement is performed, in which the ground truth measurement describes the microplastics level.

In some implementations, the action includes transmitting multiple sets of training data, the one or more sensor measurements, and the training model to one or more devices. In some implementations, the action includes adjusting a feeding system providing feed to the fish.

In some implementations, the action includes sending data indicating the output of the model to a user device, where the data is configured to, when displayed on the user device, present a user of the user device with a visual representation of an amount of microplastics in a population that includes the fish. In some implementations, determining the action includes determining to adjust a position or operation of an item of motorized equipment.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1A is a diagram showing an example of a system that is used for enhanced microplastics detection.

FIG. 1B is a diagram showing an example of a system for enhanced microplastics detection.

FIG. 2A is a flow diagram showing an example of a process for enhanced microplastics detection.

FIG. 2B is a flow diagram showing an example of a process for training a model to perform enhanced microplastics detection.

FIG. 3 is a diagram illustrating an example of a computing system used for enhanced microplastics detection.

Like reference numbers and designations in the various drawings indicate like elements.

### DETAILED DESCRIPTION

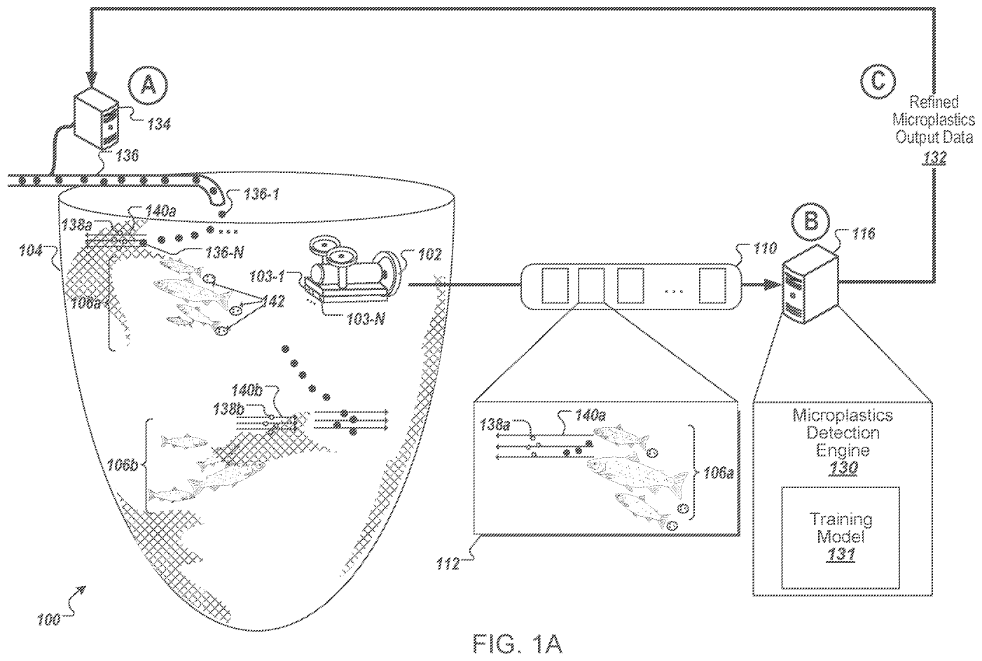

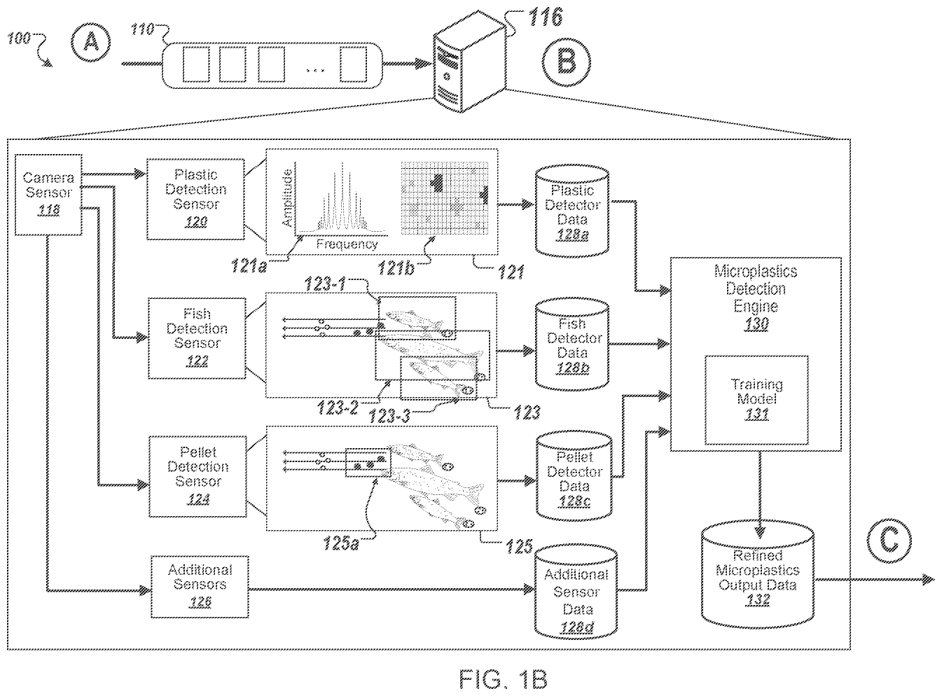

FIGS. 1A and 1B are diagrams showing an example of a system 100 that is used for enhanced microplastics detection. The system 100 includes a control unit 116 and an underwater camera device 102 (also referred to as a “camera device 102”). Generally speaking, the control unit 116 obtains images captured by a camera of the camera device 102 and processes the images. The control unit 116 can be communicably connected to the camera device 102.

The control unit 116 can detect one or more microplastics and determine actions such as feed adjustment, sorting, model training, and user report feedback, among others using the one or more microplastics detections. The example depicted in FIGS. 1A and 1B shows the control unit 116 determining an amount of microplastics using refined microplastics output data 132 based on one or more microplastics detections from the plastic detection sensor 120.

The system 100 also includes a feed controller unit 134 that controls the feed 136-1-136-N delivered by feed system 136. The feed 136-1-136-N include one or more food pellets that may be consumed by fish 106a or fish 106b. The feed controller unit 134 can include components configured to send control messages to actuators, blowers, conveyers, switches, or other components of the feed system 136. The control messages can be configured to stop, start, or change a meal e.g. number of pellets and frequency of feed 136-1-136-N provided to fish 106a or 106b in fish pen 104.

In this example, the camera device 102 includes propellers to move the camera device 102 around the fish pen 104. In general, the camera device 102 may use any method of movement including ropes and winches, waterjets, thrusters, tethers, buoyancy control apparatus, chains, among others.

In this example, the camera device 102 includes sensors 103-1-103-N (collectively referred to as “sensors 103”) to record and detect aspects e.g., turbidity, conductivity, temperature, and depth of the fish pen 104. For example, a turbidity sensor may be included to measure opaqueness in the pen due to particles e.g., sediment, algae, and microplastics in the water. In another example, a conductivity-temperature-depth (CTD) sensor may be included to measure changes in water salinity as particular particles e.g., microplastics 138a and 138b travel through the pen 104 using currents 140a and 140b, respectively.

In some implementations, the camera device 102 is equipped with the control unit 116 as an onboard component, while in other implementations, the control unit 116 is not affixed to the camera device 102 and is external to the camera device 102. For example, the camera device 102 may provide images, e.g., image 112, over a network to the control unit 116. Similarly, the control unit 116 can provide return data, including movement commands to the camera device 102 over the network.

Stages A through C of FIG. 1A and FIG. 1B, depict image data 110, including image 112, obtained by the camera device 102 that are processed by the control unit 116. The image 112 includes representations of fish including the fish 106a and 106b. Referring to FIG. 1B, the control unit 116 can include one or more processors configured to perform operations corresponding to a plastic detection sensor 120, a fish detection sensor 122, a pellet detection sensor 124, one or more additional sensors 126, or a microplastics detection engine 130. The camera sensor 118, plastic detection sensor 120, fish detection sensor 122, pellet detection sensor 124, and the additional sensors 126 can be examples of sensors 103 that are onboard the camera device 102.

The control unit 116 can be communicably connected to one or more remote processing components configured to perform operations for one or more of the plastic detection sensor 120, the fish detection sensor 122, the pellet detection sensor 124, the additional sensors 126, or the microplastics detection engine 130. Each sensor collects corresponding data including plastic detector data 128a, fish detector data 128b, pellet detection data 128c, and additional sensor data 128d, which can be stored onboard the control unit 116 or within memory of a remote device.

Referring to FIG. 1A, the obtained images from system 100 can be large (e.g., 2,000 by 2,000 pixels, 3,000 by 3,000 pixels, among others) and include portions that are not relevant for microplastics detections or classifications. The system 100 can improve efficiency (e.g., reduce storage, decrease computation time) by determining portions of obtained images that only include relevant details for microplastics detection or classification. Identified portions can be processed asynchronously, e.g., when processors of the control unit 116 are not busy with other operations. By storing images, e.g., when the processors are busy for later detection, instead of discarding them or forcing the processors to process in real time to the detriment of other processes, the system 100 can improve accuracy of microplastics detection within an environment by detecting objects that may otherwise have not been detected.

Mobile microplastics detectors identify microplastics in aquaculture environments such as oceans and fish pens (e.g., fish pen 104). The fish population (e.g., fish 106a and 106b) in the aquaculture environment (e.g., fish pen 104) inadvertently consume microplastics, which induce physical and chemical toxicity leading to health problems. Due to the relatively small size (e.g., less than 5 millimeters) of microplastics, aquatic organisms (e.g., fish 106a and 106b) have a high probability of ingestion, which causes microplastics accumulation in the bodies and tissues of the aquatic organisms. The effects of microplastics ingestion and accumulation may include various health hazards, including tissue damage, immune system disruption, oxidative stress, and general toxicity to organs. Additionally, due to the long decomposition times, the presence and risks of microplastics may be transferred when one organism consumes another organism that has consumed or ingested microplastics.

In stage A, the camera device 102 obtains the image data 110 including image 112 of fish, including the fish 106a within the fish pen 104. The image 112 also includes current 140a carrying microplastics 138a and one or more food pellets of feed 136-1-136-N. In some implementations, the image data 110 includes video data obtained by one or more cameras of the camera device 102. The camera device 102 provides the image data 110 to the control unit 116. Although image 112 shows the fish 106a in a side profile view, images of fish obtained by the camera device 102 may include fish in any conceivable pose including head on, reverse head on, or skewed. The camera device 102 may also include corresponding image data of fish 106b within the fish pen 104, by executing commands to move the camera device 102 into an appropriate position and field of view to observe fish 106b.

In stage B, the control unit 116 processes the images of the image data 110, including the image 112 using the microplastics detection engine 130 and a training model 131 trained to generated refined microplastics output data 132.

In stage C, the refined microplastics output data 132 can be provided to the feed controller 134 to adjust operations based on an amount, type, concentration, or some combination thereof, of microplastics in the fish pen 104.

FIG. 1B illustrates the control unit 116 providing the image data 110 captured and processed by the camera sensor 118 to the plastic detection sensor 120, the fish detection sensor 122, the pellet detection sensor 124, and additional sensors 126. The camera sensor 118 captures objects in the field of view of camera device 102, e.g., referring to FIG. 1A and generates image data (e.g., image data 110). The plastic detection sensor 120 detects the presence of microplastics represented in the image 112, while the fish detection sensor 122 detects one or more fish represented in the image 112. The pellet detection sensor 124 detects the presence of pellets or other types of organic food matter for fish represented in the image 112. The additional sensors 126 capture additional physical, biological, or chemical properties of objects and the environment fish pen 104; including algae, weather, etc. Each sensor described is configured to collect one or more measurements of the corresponding sensor capability.

In some implementations, the camera sensor 118 may one or more devices including an electron-multiplying charge-coupled device, a complementary metal-oxide-semiconductor (CMOS) device, or back-illuminated CMOS device.

The additional sensors 126 may include turbidity, CTD, and other kinds of oceanographic or aquaculture sensors. For example, a temperature sensor (e.g., an example additional sensor 126) may detect or measure temperature gradients represented in image 112 and store temperature readings in a corresponding sensor data structure (e.g., an example additional sensor data 128d).

In some implementations, the control unit 116 downsamples the image data 110. For example, the control unit 116 can downsample the image data 110 by generating images similar to the images of the image data 110 (e.g., representing the same features) but with fewer pixels. One or more pixels can be grouped based on their value to generate a single pixel. Values of the single pixel can be a type of average using the values of the one or more pixels. In general, the control unit 116 can decrease the resolution of the image data 110 before processing using the plastic detection sensor 120, the fish detection sensor 122, the pellet detection sensor 124, additional sensors 126, microplastics detection engine 130, or the like. Downsampling can help reduce storage requirements and decrease processing time.

In this example, the plastic detection sensor 120 performs infrared imaging or other infrared techniques e.g., Fourier Transform Infrared spectroscopy (FTIR) using the camera device 102 to detect infrared energy emitted by objects (e.g., microplastics 138a, fish 106a of FIG. 1A) in the camera device 102 field of view. The plastic detection sensor 120 receives the infrared energy (e.g., light) detections as a return signal 121a and generates a corresponding thermal map 121b describing the apparent surface temperature of the objects in the field of view, shown in image 121. In some examples, the plastic detection sensor 120 performs FTIR by determining other properties of the infrared energy (e.g., absorption, transmittance, reflectance).

In some implementations, the plastic detection sensor 120 implements alternative techniques e.g., sonar, to detect microplastics. For example, the plastic detection sensor 120 performs a sonar scan of the field of view for camera device 102 by transmitting sound waves and recording the received returns from transmitted waves to determine properties about objects in the field of view. For example, the plastic detection sensor 120 can utilize the Doppler Effect to determine relative velocity of objects in the field of view. An example return signal similar to the return signal 121a describes detections from the plastic detection sensor 120 with a corresponding spectrogram similar to the thermal map 121b, shown in image 121. The return signal 121a and thermal 121b in image 121 can be stored in plastic detector data 128a and is provided by the plastic detection sensor 120 to the microplastics detection engine 130.

In some implementations, the plastic detection sensor 120 performs other types of spectroscopy (e.g., spontaneous Raman, resonance Raman, spatially offset, etc.) to detect the presence of microplastics in fish pen 104. For example, a plastic detection sensor 120 performing Raman spectroscopy may measure relatively frequencies of scatter radiation from a sample to determine the type of microplastics material.

In this example, a corresponding sensor e.g., fish detection sensor 122 generates bounding boxes around detected objects in the image 112. Other shapes, including bounding ovals, circles, or the like, can be used to point out detected objects in the image 112. Example bounding boxes, e.g., boxes 123-1-123-3 for fish 106a, are shown in image 123. Data indicating bounding box locations and identified fish are stored in fish detector data 128b and provided by the fish detection sensor 122 to the microplastics detection engine 130.

In this example, a corresponding sensor e.g., pellet detection sensor 124 generates bounding boxes around detected objects in the image 112. Other shapes, including bounding ovals, circles, or the like, can be used to point out detected objects in the image 112. Example bounding boxes, e.g., box 125a for at least one pellet of feed 136-1-136-N, are shown in image 125. Data indicating bounding box locations and identified feed pellets are stored in pellet detector data 128c and provided by the pellet detection sensor 124 to the microplastics detection engine 130.

The plastic detection sensor 120 obtains plastic detection data and detects the presence of microplastics particles (e.g., microplastics 138a and 138b). The types of detections can record characteristics (e.g., size, reflectivity, shapes, location) about the microplastics particles. Plastic detections can be stored as plastic detection data 128a prior to being provided to the microplastics detection engine 130. The control unit 116 can specify and adjust operating parameters of the plastic detection sensor 120, but also receive information to instruct the control unit 116 to detect one or more types of microplastics (e.g., microbeads, fibers, fragments) in the image data 110. The information can be provided by a user or as part of an automated detection program.

In some implementations, processed sensor data (e.g., thermal map 121) from the plastic detection sensor 120 include altered image characteristics. For example, the control unit 116 can mask a portion of image 112, e.g., fish 106a. In one case, the control unit 116 can mask a portion of the image 112 that does not represent a body of an microplastics of interest (e.g., fish 106a). The mask can set pixel values to a predetermined value. Masked images may be compressed to minimize storage requirements by storing a first set of one or more masked pixels as a second set of one or more values where the second set of one or more values occupies less storage space than the first set of one or more masked pixels. The control unit 116 can apply color filters or the like to visually alter processor sensor data, e.g., to optimize later processing performed by microplastics detection engine 130.

In some implementations, the control unit 116 determines which of the image data 110 to store, process, or discard. The control unit 116 can determine which of the image data 110 to store, process, or discard using data, e.g., capabilities of the camera, capabilities of a cloud processing device, quality of a patch, bandwidth or processing load of one or more processors operating the plastic detection sensor 120, among others. For example, the control unit 116 can determine a quality (e.g., value of 0 to 1, 0 to 100, among others) of an image (e.g., image 112) using one or more algorithms or trained models (e.g., training model 131 of microplastics detection engine 130). The control unit 116 can determine the quality of the image 112 using features of a image include clarity of lines, blurriness, occlusions, among others. The control unit 116 can compare a determined quality of the image to a threshold value. Based on the comparison, the control unit 116 can determine whether to discard the image or to process or store the image.

In another example, the control unit 116 can determine a current bandwidth of one or more processors operating the one or more detection sensors (e.g., plastic detector sensor 120). In some implementations, one or more detection sensors are operated by a cloud computing system. In some implementations, the one or more detection sensors are operated by a system included in the control unit 116. The system (e.g., cloud based or internal) operating the one or more detection sensors can transmit processing load data to the control unit 116. The control unit 116 can determine, using processing load data received by the control unit 116, either a current processing load of the system or a projected future processing load. If a current or projected processing load satisfies a threshold, the control unit 116 can determine whether to store or provide detection sensor data (e.g., plastic detector data 128a) to the system for processing. In general, when there is available bandwidth, the control unit 116 can provide patches to be processed and when there is not available bandwidth, the control unit 116 can store the detection sensor data.

In some implementations, the control unit 116 provides detection sensor data to a processing system operating the one or more detection sensors as processing bandwidth becomes available. For example, the control unit 116 can provide detection sensor data to a system (e.g., cloud based or internal) operating the corresponding detection sensor. In general, processing systems can operate one or more of detection sensors (e.g., plastic detection sensor 120) and or the microplastics detection engine 130. The control unit 116 can provide data from one or more detection sensors to a system after receiving from the system an indication of available bandwidth. The control unit 116 can provide detection sensor data to a system and, if after a set amount of time the control unit 116 does not receive response data acknowledging the provided detection sensor data or indicating a processing being or already performed, the control unit 116 can again provide data from one or more detection sensors.

The control unit 116 can store the one or more detection sensor data (e.g., plastic detector data 128a) and keep providing the detection sensor data to be processed until they are processed, e.g., when a processing system has available bandwidth. A process scheduler of one or more processors operating a detection sensor (e.g., the plastic detection sensor 120) can incorporate processing plastic detection data 128a provided to them into a schedule with one or more other operations requiring processing. In some implementations, a schedule of processing detection sensor data (e.g., plastic detector data) can be low, especially if the detection sensor data is stored and can be processed at any time, indicating that other processes are to be prioritized over the detection sensor data processing.

In general, microplastics can be easier to detect in a cropped version of an image. There are fewer elements that operate as a distraction and grounds for error in a smaller image cropped on an area of interest for detection than a larger initial image. An image patch can look more like images in training sets (e.g., a training set only needs images of microplastics and adipose fin regions; it may not have lots of net, marine snow, or other distracting backgrounds or other elements).

In some implementations, whether the plastic detection sensor 120 provides plastic detector data 128a to the microplastics detection engine 130 depending on a processing load of the control unit 116. For example, the plastic detection sensor 120 can determine a current processing load or a projected processing load based on items to be processed by the microplastics detection engine 130 in the future. Using a current or projected processing load, the plastic detection sensor 120 can determine how many, if any, images (e.g., image 121) to be sent to the microplastics detection engine 130.

In some implementations, the plastic detection sensor 120 stores all plastic detections (e.g., plastic detection data 128a) and does not provide patches to the microplastics detection engine 130. For example, the microplastics detection engine 130 can obtain detections (e.g., return signal 121a) or images (e.g., map 121b) from the plastic detection data 128a as the microplastics detection engine 130 has available processing bandwidth.

The microplastics detection engine 130 receives detection sensor data (e.g., plastic detector data 128a, fish detector data 128b, pellet detector data 128c, and additional sensor data 128d) from one or more detection sensors. In this case, the plastic detection sensor 120 provides plastic detection data 128a to the microplastics detection engine 130 as an initial estimate of the presence of microplastics in fish pen 104. The microplastics detection engine 130 incorporates detection sensor data from one or more detection sensors into training model 131 to improve the precision and accuracy of detected microplastics in fish pen 104. For example, an image 112 may include the presence of one or more food pellets 136-1-136-N similar in shape and size to the microplastics 138a of current 140a, in which the plastic detection sensor 120 may incorrectly classify microplastics 138a as one or more food pellets 136-1-136-N.

The microplastics detection engine 130 provides the one or more detection sensor data to a training model 131 to perform additional processes and refine microplastics detections. The training model 131 can consist of one or more additional models trained to detect microplastics, such as microbeads, plastic pellets (e.g., nurdles), plastic fibers (e.g., nylon). The training model 131 can also be trained using the detection sensor data (e.g., from a corresponding plastic detection sensor 120), images 110 from camera sensor 118, and additional sensor data 128 (e.g., sensors to detect biomass, weather prediction, algae prediction) to discern microplastics from other obstructions (e.g., algae, food pellets, marine snow). For example, the training model 131 can override a microplastics misclassified as a food pellet, providing the correct microplastics classification and storing the result in refined microplastics output data 132.

The training model 131 uses the one or more additional sensors to incorporate measurements of respective characteristics (e.g., temperature, salinity, and pressure). The training model 131 may infer a higher concentration (e.g., one or more particles) of microplastics at boundary layers between contrasting sensor properties. For example, the training model 131 may utilize salinity measurements to identify a halocline (e.g., rapid increase in salinity at a certain depth) to infer a higher concentration of microplastics at the halocline. Other example boundaries may include thermoclines (e.g., rapidly changing temperature) and pycnoclines (e.g., rapidly changing density).

The training model 131 can perform a variety of training techniques to improve microplastics detections in fish pen 104, including supervised and unsupervised learning. In some examples, the training model 131 performs hybrid-learning techniques to improve microplastics detection. Additional processes of the training model 131 include improving current estimates of microplastics in fish pen, trend predictions of microplastics levels over one or more time periods, classification and clustering of microplastics based on characteristics (e.g., type, size). The training model 131 can utilize the one or more training techniques to generate an improvement in classification, quantification, etc. of microplastics and stores the results in refined microplastics output data 132.

In some implementations, the training model 131 can be trained using obtained ground truth data of actual microplastics numbers (e.g., obtained through manual counting, water sampling, among others) and number of microplastics detections. The control unit 116 can adjust one or more weights or parameters of the trained model such that predictions of the training model 131 using plastic detections as input, match the ground truth data of microplastics level. After training, the training model 131 of the microplastics detection engine 130 can be used to determine a microplastics level using plastics detections from a portion of fish within a pen, e.g., the fish pen 104.

In some implementations, the training model 131 includes one or more fully or partially connected layers. Each of the layers can include one or more parameter values indicating an output of the layers. The layers of the training model 131 can generate output indicating a severity of microplastics (e.g., refined microplastics output data 132) within a population. A microplastics level from the refined microplastics output data 132 can be used to perform one or more actions.

In stage C, the control unit 116 determines an action based on output (e.g., refined microplastics output data 132) of the microplastics detection engine 130. In some implementations, the microplastics detection engine 130 determines an action based on processing one or more detections processed by the plastic detector 120

The microplastics detection engine 130 can generate a microplastics level, e.g., an average concentration of microplastics in parts-per-million from the refined microplastics output data 132. The microplastics detection engine 130 the microplastics level to one or more thresholds, e.g., a threshold average number of microplastics, a threshold percentage of microplastics (relative to detected objects in the fish pen), a threshold microplastics severity for one or more fish, among others. If the microplastics level satisfies one or more thresholds, the control unit 116 can determine an action (e.g., sorting, configuring feed systems, among others).

In some implementations, the control unit 116 determines an adjustment of feed 136-1-136-N using the feed controller unit 134 controlling the feed system 136. The control unit 116 can provide the output (e.g., refined microplastics output data 132) of the microplastics detection engine 130 or a control signal to the feed controller unit 134. Depending on the data received from the control unit 116, the feed controller unit 134 can either process the refined microplastics output data 132 to determine an adjustment of feed and provide a control signal to the feed system 136 or can provide the control signal provided by the control unit 116 to the feed system 136.

In some implementations, the control unit 116 provides a control signal to an actuator. For example, the actuator can be part of a sorting system to sort one or more fish from one or more other fish. The control unit 116 can sort the fish 106 based on microplastics consumption. Fish that consumed one or more microplastics particles (e.g., microplastics 138a or 138b), or microplastics consumption above a threshold severity (e.g., detections of microplastics elements per fish) can be sorted from one or more fish in the fish pen 104. In some cases, healthy fish can be sorted into another pen separated from the fish that consume microplastics.

In some implementations, the control unit 116 includes the feed controller unit 134. For example, the control unit 116 may control both the processing of the image data 110 and the adjustments to the feeding by controlling the feed system 136.

In some implementations, the control unit 116 adjusts feeding to provide feed 136-1-136-N to a certain area of the fish pen 104. For example, the obtained image data 110 can include positions of the fish detected within the obtained image data 110. The control unit 116 can determine based on one or more subpopulations detected by the control unit 116 that a given subpopulation requires additional feed.

The control unit 116 can send a control signal to the feed system 136 or to the control unit 130 for the feed system 136 configured to adjust the location of an output of feed 136-1-136-N. The control unit 116 can adjust the location of an output of feed to a location of one or more fish within a particular subpopulation or an average location of the subpopulation.

In some implementations, the feed system 136 includes multiple food types. For example, the controller unit 134 can provide control messages to the feed system 136 to change the food type provided to the fish 106a and fish 106b. In some cases, the multiple food types include food with a particular nutritional value and food with a different nutritional value.

The feed controller unit 134 can determine, based on data from the control unit 116, which food to provide to the fish 106a and 106b, how much food to provide, when to provide the food, and at what rate to provide the food. In general, the feed controller unit 134 can generate a meal plan based on data from the control unit 116 where the meal plan includes one or more of: a feed type, a feed rate, a feed time, and a feed amount.

In some implementations, the control unit 116 includes multiple computer processors. For example, the control unit 116 can include a first and a second computer processor communicably connected to one another. The first and the second computer processor can be connected by a wired or wireless connection. The first computer processor can perform one or more of the operations of the plastic detection sensor 120, the fish detection sensor 122, the pellet detection sensor 124, or the microplastics detection engine 130. The first computer processor can store or provide data to or from any of the plastic detection sensor 120, the fish detection sensor 122, the pellet detection sensor 124, or the microplastics detection engine 130.

Similarly, the second computer processor can perform one or more of the operations of the plastic detection sensor 120, the fish detection sensor 122, the pellet detection sensor 124, or the microplastics detection engine 130. The second computer processor can store or provide data to or from any of the plastic detection sensor 120, the fish detection sensor 122, the pellet detection sensor 124, or the microplastics detection engine 130. Operations not performed by the first computer processor can be performed by the second computer processor or an additional computer processor. Operations not performed by the second computer processor can be performed by the first computer processor or an additional computer processor.

In some implementations, the control unit 116 operates one or more processing components, such as the plastic detection sensor 120, the fish detection sensor 122, the pellet detection sensor 124, or the microplastics detection engine 130. In some implementations, the control unit 116 communicates with an external processor that operates one or more of the processing components. The control unit 116 can store data used to train one or more models of the processing components or can communicate with an external storage device that stores training data.

In some implementations, an image patch identified by the plastic detection sensor 120 is a portion (e.g., 10 percent) of an original image captured by the camera device 102. An original image can be captured from a mono camera, stereo camera, or a setup with more than two cameras. In some implementations, blue and green, or other color combination lights (e.g., blue and red, among others), are used to illuminate images captured by the camera device 102. For example, images can be captured in pairs where one image of the pair is illuminated with a first color light (e.g., blue) and another image of the pair is illuminated with a second color light (e.g., red). Other colors or frequencies of light can be used.

In some implementations, an image patch identified by the plastic detection sensor 120 is a portion (e.g., 10 percent) of a downsampled image generated using an original image captured by the camera device 102.

In some implementations, portions that are occluded, or partially occluded or obscured are not extracted as patches. For example, the plastic detection sensor 120 can detect the region corresponding to the patch 124a. The patch detector 122 can determine that the region corresponding to the patch 124a is partially occluded by the fish 113. The patch detector 122 can remove the detected patch 124a from patches 126 for subsequent processing.

In some implementations, obscuring, e.g., marine snow, dust, atmospheric effects, among others, degrade a quality of detections for the plastic detection sensor 120. For example, microplastics further away than fish 106a from a camera can be detected. Due to the distance and debris in the water, the quality of any detected microplastics more than a threshold distance from a camera can be low. Based on a quality determination, the plastic detection sensor 120 can determine one or more detections for subsequent processing. Quality determination can include processing by a model trained to determine one or more values indicating a quality of an image. Quality can indicate the confidence or accuracy of subsequent object detection using that image.

In some implementations, the plastic detection sensor 120 detects relevant patches of images for processing by detecting specific elements of microplastics. For example, the plastic detection sensor 120 can include an image recognition algorithm trained to detect the dispersion of microplastics based of known densities. The plastic detection sensor 120 can identify a specific element, e.g., an porous surface of a microplastics, and detect the microplastics using its porousness.

For example, the plastic detection sensor 120 can generate mappings (e.g., thermal map 121b) of detected microplastics including a cloud of microplastics traveling through a fish pen 104 (e.g., microplastics 138a and 138b). The mapping can include one edge at the start of a location corresponding to one end of a cloud of microplastics, and extend a fixed or variable amount away from the location to the other end of the cloud of microplastics.

The plastic detection sensor 120 can detect the area and extract or identify the area as data for processing. In some implementations, mappings, e.g., thermal mapping 121b, include an x by y pixel portion of an X by Y pixel image, e.g., image 112, where x is less than X and y is less than Y. Patches can include the same number of pixels as a corresponding portion of the X by Y image or can be sampled, either up or down, to include more pixels than the corresponding portion of the X by Y. A system can be optimized to include enough pixels for accurate image analysis while minimizing image size to reduce storage and increase processing efficiency.

In some implementations, a feedback system is used with a set of image patches where initial images, for a given detection goal (e.g., plastic detection), are high definition and include many pixels. The control unit 116 can process images and generate detection results, e.g., from the plastic detection sensor 120. The control unit 116 can compare the detection results with ground truths. If the accuracy of the detection results satisfy a threshold, the control unit 116 can process an additional round. For the additional round, the control unit 116 or connected system can downsample the patches by an amount so that they include fewer pixels. Adjacent pixels can be averaged together. Downsampling algorithms can be used. The downsampled patches can be processed by the control unit 116 to generate detection results, obtained by a detection system, e.g., plastic detection sensor 120. Again, the control unit 116 can compare the detection results to a threshold. This can continue until detection result accuracy does not satisfy a threshold. The control unit 116 can upsample or revert back the patches from that round to a previous round fidelity. For future processing, the system, such as the system 100 and the control unit 116 can downsample patches to a degree indicated by the iterative approach described above to optimize the resolution needed for accurate detection while minimizing storage.

In some implementations, there are no identified microplastics in an image. In some implementations, there are many (e.g., 10, 100, 1000) of microplastics in an image. In some implementations, the quantity of microplastics found varies by environment. In some implementations, the likelihood of fish consuming microplastics varies on the species and size of the fish. For example, sharks, grouper, and tuna (e.g., marine organisms that consume or hunt other fish) are more likely to ingest greater amounts of microplastics. In some examples, fish at earlier stages of development (e.g., spawning) are less likely or unable to consume microplastics.

In some implementations, the control unit 116 includes a microplastics detection model (e.g., training model 131) that processes full images to generate a training set that identifies the quantity, type, and presence of microplastics. For example, a detection model can process images of known microplastics. The detection model can determine one or more characteristics (e.g., size, reflectivity, thermal conductivity) of the microplastics. In some implementations, a user checks areas of interest for a given microplastics based on predictions generated by the detection model. For example, a user can use scientific understanding of microplastics to determine what areas of a fish would be logically affected.

In some implementations, the control unit 116 processes full images before processing new images, such as the image data 110. For example, the control unit 116 can process one or more images to determine one or more regions of interest for a given microplastics. After determining what regions are of interest, the control unit 116 can perform the microplastics detection described in reference to FIGS. 1A and 1B to detect the presence of microplastics in a population of fish. The control unit 116 can then perform an action in response to detecting a threshold amount of the microplastics.

In some implementations, images are processes asynchronously. For example, if there are many regions of interest in an image, it might not be possible to process all images at once given computational constraints. An image can be saved for processing at a later time (e.g., when there is less computational load on the system). Saving just 10% of an image takes less space than saving 100% of an image. Based on schooling of fish, images obtained from the camera device 102 may suddenly be filled with fish as a school swims past a camera of the camera device 102 or the camera device 102 moves past a school. Images of schools of fish, where there may be many areas of interest, may be obtained following or preceding images of empty water. The system 100 described in FIGS. 1A and 1B can help solve the issue of unequalized process requirements of obtained images while reducing storage requirements and decreasing processing time.

In some implementations, a first number of microplastics detected by the plastic detection sensor 120 are provided to the microplastics detection engine 130 for further processing. In general, processing some plastic detection data 128a is better than processing none, or better than having biases when the computer is overwhelmed. This approach may be useful with constrained storage requirements or cost concerns that make storage of detected patches infeasible.

Biases when a computer, such as the control unit 116, is overwhelmed, includes undercounting when there are more microplastics of interest identified than the plastic detection sensor 128 can process given processing constraints. In this case, a system can miss opportunities to identify microplastics when there are many fish in a scene and may have a bias where the system undercounts when there are many fish swimming by.

These methods of identifying microplastics of interest, among others, can be performed on partial resolution versions of images (e.g., a 2000 by 2000 pixel image can be reduced to 600 by 600 pixels before going into a model, such as the training model 131 of the microplastics detection engine 130).

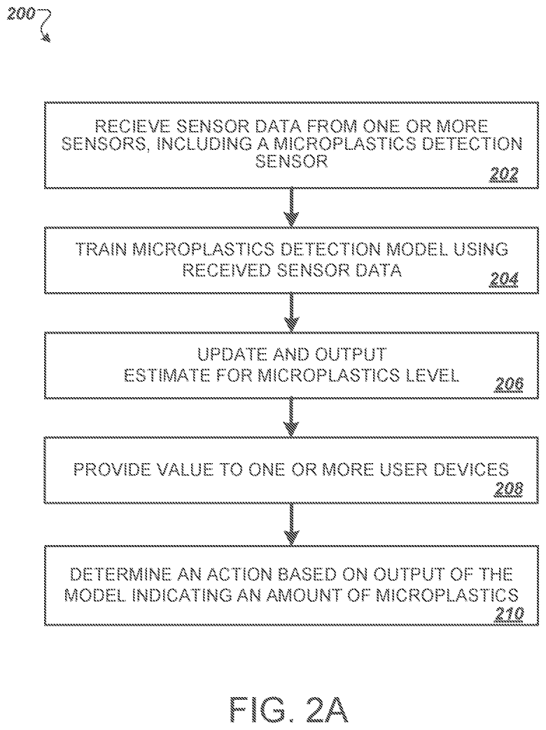

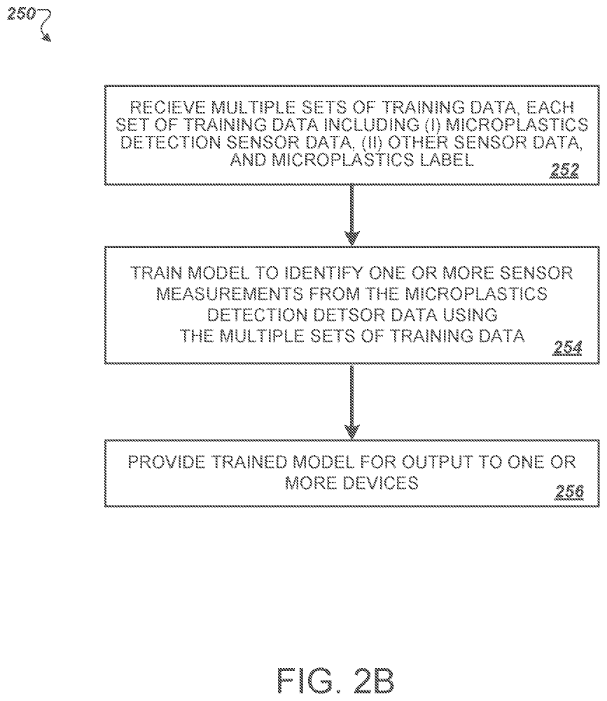

FIG. 2A is a flow diagram showing an example of a process 200 for enhanced microplastics detection. The process 200 may be performed by one or more systems, for example, the system 100 of FIGS. 1A and 1B.

The process 200 includes receiving sensor data from one or more sensors, including a microplastics detection sensor (202). The control unit 116, for example, can capture image data 110 from the camera device 102 and one or more other sensors including plastic detection sensor 120, fish detection sensor 122, etc. The one or more sensors can identify characteristics about the received image data 110 and store results in corresponding databases. At least one of the sensors include a microplastics detection sensor (e.g., plastic detection sensor 120), to detect an estimated value or level associated with microplastics present.

The process 200 includes training a microplastics detection model using the received sensor data from the one or more sensors, including the microplastics detection sensor (204). For example, the control unit 116 provides plastic detector data 128a, fish detector data 128b, pellet detector data 128c, and additional sensor data 128d to the microplastics detection engine 130. The training model 131 (e.g., a microplastics detection model) uses the data from the one or more sensors to refine and output an improved estimate for a value or level associated with the microplastics present (e.g., refined microplastics output data 132). The training model 131 can implement one or more additional models to detect, quantify, and identify microplastics.

The process 200 includes updating the value or level associated with the microplastics present using the refined estimate from the microplastics detection engine (206). For example, the plastic detection sensor 120 can provide an initial estimate of detected microplastics in fish pen 104. The training model 131 of microplastics detection engine 130 can generate an improved estimate from the refined microplastics output data 132; the improved estimate also describing detected microplastics in fish pen 104. The microplastics detection engine 130 can override the initial estimate provided by the plastic detection sensor 120 with the improved estimate.

The process 200 includes providing the improved estimate or value of detected microplastics to one or more user devices (208). For example, the microplastics detection engine 130 can transmit the improved estimate from refined microplastics output data 132 to control unit 116 (e.g., a user device).

The process 200 includes determining an action based on output of the model indicating an amount of microplastics (210). For example, the microplastics detection engine 130 can obtain plastic detection data from the plastic detection sensor 120. Based on the detections and prior training using one or more detections and ground truth data of microplastics levels, the microplastics detection engine 130 can generate a value indicating a microplastics level in the fish pen 104.

In some implementations, the action includes adjusting a feeding system providing feed to fish. For example, the control unit 116 can provide the output of the microplastics detection engine 130 or a control signal to the feed controller unit 134. Depending on the data received from the control unit 116, the feed controller unit 134 can either process the output (e.g., refined microplastics output data 132) of the microplastics detection engine 130 to determine an adjustment of feed and provide a control signal to the feed system 136 or can provide the control signal provided by the control unit 116 to the feed system 136.

In some implementations, the action includes sending data to a user device, where the data is configured to, when displayed on the user device, present a user of the user device with a visual representation of microplastics levels in an environment. In some implementations, the control unit 116 waits for feedback from a user who is provided, e.g., by the control unit 116, a visual representation to confirm an action determined by the control unit 116, such as a feed adjustment.

FIG. 2B is a flow diagram showing an example of a process 250 for training a model to perform enhanced microplastics detection. The process 250 can be performed by a computing device, such as control unit 116 described in reference to FIGS. 1A and 1B above.

The process 250 includes receiving multiple sets of training data by a microplastics detection engine, each set of training data including microplastics detection sensor data, other sensor data associated with an underwater camera system, and a label indicating an amount of microplastics (252). The sensor data associated with the underwater camera system can include fish detector data 128b, pellet detector data 128c, and additional sensor data 128d from the fish detection sensor 122, the pellet detection sensor 124, and additional sensors 126, respectively. Examples of additional sensors 126 can include sensors to measure turbidity, water salinity, and other characteristics objects and water in an aquaculture environment.

In some implementations, the process 250 includes comparing sensor measurements from microplastics detection sensor data to a ground truth measurement. The ground truth measurement can indicate a microplastics level of the aquaculture environment, e.g., sampled and analyzed through spectroscopy.

The process 250 includes training a model to identify one or more sensor measurements from the microplastics detection sensor data using the multiple sets of training data (254). Identifying sensor measurements can include training to the model to identify particular sensors measurements correspond to a type, amount, concentration, or some combination thereof, of microplastics in the fish pen.

The process 250 includes providing the trained model for output by the microplastics detection engine for use by one or more devices (256). In some implementations, providing the trained model, e.g., training model 131, can include transmitting multiple sets of training data utilized for training the model to one or more devices, e.g., a computing device. In some implementations, providing the trained model also includes transmitting sensor measurements associated with training the model to one or more devices.

In some implementations, one or more actions can be performed by one or more devices based on receiving at least one or more of (i) the multiple sets of training data, (ii) the one or more sensor measurements, or (iii) the trained model. The actions performed by device, e.g., a feeding system, configures the device to adjust operation in the aquaculture environment, e.g., fish pen 104. For example, actions for a feeding system of an aquaculture environment can include adjusting an amount of feed, as well as feeding schedules, e.g., time to dispense feeds.

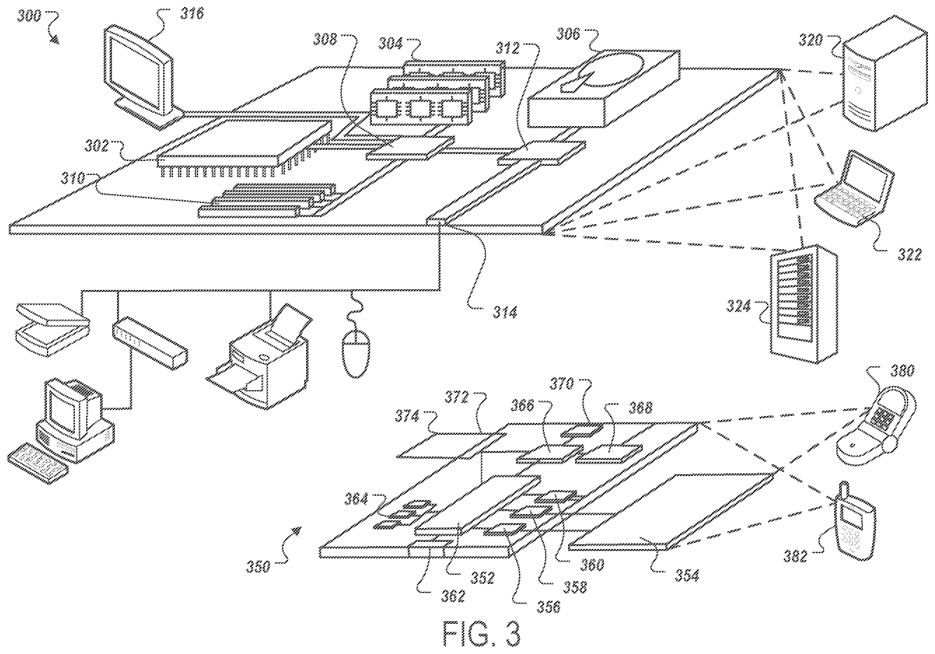

FIG. 3 is a diagram illustrating an example of a computing system used for enhanced microplastics detection. The computing system includes computing device 300 and a mobile computing device 350 that can be used to implement the techniques described herein. For example, one or more components of the system 100 could be an example of the computing device 300 or the mobile computing device 350, such as a computer system implementing the control unit 116, devices that access information from the control unit 116, or a server that accesses or stores information regarding the operations performed by the control unit 116.

The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate. The processor 302 can process instructions for execution within the computing device 300, including instructions stored in the memory 304 or on the storage device 306 to display graphical information for a Graphical User Interface (GUI) on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 302 is a single threaded processor. In some implementations, the processor 302 is a multi-threaded processor. In some implementations, the processor 302 is a quantum computer.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 302), perform one or more methods, such as those described above. The instructions can also be stored by one or more storage devices such as computer- or machine readable mediums (for example, the memory 304, the storage device 306, or memory on the processor 302). The high-speed interface 308 manages bandwidth-intensive operations for the computing device 300, while the low-speed interface 312 manages lower bandwidth-intensive operations. Such allocation of functions is an example only. In some implementations, the high speed interface 308 is coupled to the memory 304, the display 316 (e.g., through a graphics processor or accelerator), and to the high-speed expansion ports 310, which may accept various expansion cards (not shown). In the implementation, the low-speed interface 312 is coupled to the storage device 306 and the low-speed expansion port 314. The low-speed expansion port 314, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may include one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (nonvolatile random access memory). In some implementations, instructions are stored in an information carrier such that the instructions, when executed by one or more processing devices (e.g., processor 352), perform one or more methods, such as those described above. The instructions can also be stored by one or more storage devices, such as one or more computer or machine-readable mediums (for example, the memory 364, the expansion memory 374, or memory on the processor 352). In some implementations, the instructions can be received in a propagated signal, for example, over the transceiver 368 or the external interface 362.

The mobile computing device 350 may communicate wirelessly through the communication interface 366, which may include digital signal processing circuitry in some cases. The communication interface 366 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 3G/6G cellular, among others. Such communication may occur, for example, through the transceiver 368 using a radio frequency. In addition, short-range communication may occur, such as using a Bluetooth, Wi-Fi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, among others) and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

In conclusion, these techniques described herein will improve microplastics detection in aquaculture environments and help improve overall fish health and well-being. Supporting aquaculture environments and farming practices can provide a sustainable alternative to current farming practices, including cattle farming. For example, the global demand for beef products has led to the rapid deforestation of rainforests to create grazing lands for cattle farming. Deforestation of rainforests leads to increased carbon emissions and reduced carbon sequestration (e.g., trees converting carbon emissions into oxygen), thereby greatly exacerbating climate change. Aquaculture, however, serves a highly sustainable alternative to raise and farm fish for consumption as a protein substitute to beef. For example, raising and farming fish requires far less feed (e.g., improved feed conversion ratio) compared to raising and farming cattle for beef. Aquaculture also does not have an adverse effect on carbon sequestration and far less carbon emissions compared to cattle farming. Additionally, the water footprint of aquaculture is far more sustainable (e.g., re-usable or recyclable) compared to the water footprint associated with cattle farming. Improved microplastics detectability and accuracy allows more prevention measures to be implemented in aquaculture environments, resulting in fish consuming fewer microplastics. Reduced microplastics consumption by fish will improves fish well-being, health, and happiness—thereby also supporting sustainable marine ecosystems and human consumption demands.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM (erasable programmable read-only memory), EEPROM (electrically erasable programmable read-only memory), and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

What is claimed is:

1. A computer-implemented method comprising:
receiving, by a microplastics detection engine of an underwater camera system that includes (i) the microplastics detection engine, (ii) a microplastics detection sensor, and (iii) one or more other sensors:
microplastics detection data representing a sensor measurement from the microplastics detection sensor, and
additional sensor data from the one or more other sensors;
providing, the sensor measurement of the microplastics detection data from the microplastics detection sensor and at least one measurement of the additional sensor data from the one or more other sensors to a model that is trained to output one or more values that reflect an amount of microplastics based on sensor data from multiple sensors including the microplastics detection sensor;
in response to providing the microplastics detection data and the at least one measurement of the additional sensor data, receiving, by the microplastics detection engine, one or more particular values that reflect an amount of microplastics based on the microplastics detection data from the microplastics detection sensor and the additional sensor data from the one or more other sensors; and
providing, by the microplastics detection engine, a representation of the one or more values for output.

2. The computer-implemented method of claim 1, comprising:
determining the representation of the one of more values for output is greater than a threshold value, indicating the presence of microplastics.

3. The computer-implemented method of claim 1, comprising:
obtaining a type of microplastics to be detected by the trained model.

4. The computer-implemented method of claim 1, comprising:
obtaining at least one or both of a quantity or concentration of microplastics to be detected by the trained model.

5. A computer-implemented method comprising:
receiving, by a microplastics detection engine of an underwater camera system, multiple sets of training data, each set including (i) microplastics detection sensor data, (ii) other sensor data associated with an underwater camera system, and (iii) a label indicating an amount of microplastics;
training a model to identify one or more sensor measurements from the microplastics detection sensor data, using the multiple sets of training data; and
providing the trained model for output by the microplastics detection engine of the underwater camera system for use by one or more devices.

6. The computer-implemented method of claim 5, comprising:
comparing the one or more sensor measurements from the microplastics detection sensor data to a ground truth measurement, in which the ground truth measurement describes the microplastics level.

7. The computer-implemented method of claim 5, comprising:
transmitting the multiple sets of training data, the one or more sensor measurements, and the trained model to the one or more devices.

8. The computer-implemented method of claim 5, comprising:
performing an action upon receipt of at least the multiple sets of training data, the one or more sensor measurements, or the trained model, in which the action configures one or more devices.

9. The computer-implemented method of claim 5, comprising:
configuring one or more devices to perform the action, in which the action includes adjusting a feeding system.

10. A non-transitory, computer-readable medium storing one or more instructions executable by a computer system to perform operations comprising:
receiving, by a microplastics detection engine of an underwater camera system that includes (i) the microplastics detection engine, (ii) a microplastics detection sensor, and (iii) one or more other sensors:
microplastics detection data representing a sensor measurement from the microplastics detection sensor, and
additional sensor data from the one or more other sensors;
providing, the sensor measurement of the microplastics detection data from the microplastics detection sensor and at least one measurement of the additional sensor data from the one or more other sensors to a model that is trained to output one or more values that reflect an amount of microplastics based on sensor data from multiple sensors including the microplastics detection sensor;
in response to providing the microplastics detection data and the at least one measurement of the additional sensor data, receiving, by the microplastics detection engine, one or more particular values that reflect an amount of microplastics based on the microplastics detection data from the microplastics detection sensor and the additional sensor data from the one or more other sensors; and
providing, by the microplastics detection engine, a representation of the one or more values for output.

11. The non-transitory, computer-readable medium of claim 10, wherein the operations comprise:
determining the representation of the one of more values for output is greater than a threshold value, indicating the presence of microplastics.

12. The non-transitory, computer-readable medium of claim 10, wherein the operations comprise:
obtaining a type of microplastics to be detected by the trained model.

13. The non-transitory, computer-readable medium of claim 10, wherein the operations comprise:
obtaining at least one or both of a quantity or concentration of microplastics to be detected by the trained model.

14. The non-transitory, computer-readable medium of claim 10, the operations further comprising:
receiving, by a microplastics detection engine of an underwater camera system, multiple sets of training data, each set including (i) microplastics detection sensor data, (ii) other sensor data associated with an underwater camera system, and (iii) a label indicating an amount of microplastics;
training a model to identify one or more sensor measurements from the microplastics detection sensor data, using the multiple sets of training data; and
providing the trained model for output by the microplastics detection engine of the underwater camera system for use by one or more devices.

15. The non-transitory, computer-readable medium of claim 14, the operations further comprising:
comparing the one or more sensor measurements from the microplastics detection sensor data to a ground truth measurement, in which the ground truth measurement describes the microplastics level.

16. The non-transitory, computer-readable medium of claim 14, the operations further comprising:
transmitting the multiple sets of training data, the one or more sensor measurements, and the trained model to the one or more devices.

17. The non-transitory, computer-readable medium of claim 14, the operations further comprising:
performing an action upon receipt of at least the multiple sets of training data, the one or more sensor measurements, or the trained model, in which the action configures one or more devices.

18. A computer-implemented system comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, by a microplastics detection engine of an underwater camera system that includes (i) the microplastics detection engine, (ii) a microplastics detection sensor, and (iii) one or more other sensors:
microplastics detection data representing a sensor measurement from the microplastics detection sensor, and
additional sensor data from the one or more other sensors;
providing, the sensor measurement of the microplastics detection data from the microplastics detection sensor and at least one measurement of the additional sensor data from the one or more other sensors to a model that is trained to output one or more values that reflect an amount of microplastics based on sensor data from multiple sensors including the microplastics detection sensor;
in response to providing the microplastics detection data and the at least one measurement of the additional sensor data, receiving, by the microplastics detection engine, one or more particular values that reflect an amount of microplastics based on the microplastics detection data from the microplastics detection sensor and the additional sensor data from the one or more other sensors; and
providing, by the microplastics detection engine, a representation of the one or more values for output.

19. The system of claim 18, the operations further comprising:
receiving, by a microplastics detection engine of an underwater camera system, multiple sets of training data, each set including (i) microplastics detection sensor data, (ii) other sensor data associated with an underwater camera system, and (iii) a label indicating an amount of microplastics;
training a model to identify one or more sensor measurements from the microplastics detection sensor data, using the multiple sets of training data; and
providing the trained model for output by the microplastics detection engine of the underwater camera system for use by one or more devices.

20. The system of claim 18, wherein the operations further comprise:
determining the representation of the one of more values for output is greater than a threshold value, indicating the presence of microplastics.

21. The system of claim 18, wherein the operations further comprise:
obtaining at least one (i) a type, (ii) a quantity, or (iii) a concentration, of microplastics to be detected by the trained model.
